(19) United States
(12) Patent Application Publication
(10) Pub. No.: US 2019/0003636 A1
(43) Pub. Date: Jan. 3, 2019

(54) PHOTOGRAPHIC EQUIPMENT SUPPORTING ROD

(71) Applicant: ZHONGSHAN ISTABILIZER PHOTOGRAPHY TECHNOLOGY CO., LTD., Zhongshan (CN)

(72) Inventors: Limei Wen, Zhongshan (CN); Gui Li, Zhongshan (CN); Lifeng Yu, Zhongshan (CN)

(21) Appl. No.: 16/062,221

(22) PCT Filed: Aug. 31, 2016
(86) PCT No.: PCT/CN2016/097570

§ 371 Date: Jun. 14, 2018

(30) Foreign Application Priority Data
Jun. 16, 2016 (CN) 201620600767.2

(51) Int. Cl. F16M 11/40; B29C 44/12

(52) U.S. Cl. CPC F16M 11/40; G03B 17/563; B29C 44/1219

(57) ABSTRACT

A photographic equipment supporting rod comprising an inner core and a jacket, wherein the jacket wraps outside the inner core integrally or wraps a part of the inner core integrally. The jacket can be directly formed on the inner core by using injection moulding or foam moulding during production, without respectively process and assemble the inner core and the sheath, which requires less dimension accuracy, and is not necessary to additionally provide a connecting structure. Therefore, the manufacturing process can be effectively simplified, the production efficiency can be improved, and the production cost can be reduced. Moreover, since the inner core and the jacket are integrated, relative sliding is less likely to occur during use, which can effectively prevent the jacket from being worn, so as to prolong the service life thereof.

### CROSS-REFERENCE TO RELATED APPLICATIONS

This application is a national stage application under 35 U.S.C. 371 of PCT Application No. PCT/CN2016/097570 having an international filing date 31 Aug. 2016, which PCT application claimed the benefit of CN Application No. 201620600767.2CN filed 16 Jun. 2016, the entire disclosure of each of which are hereby incorporated herein by reference.

### TECHNICAL FIELD

The present disclosure relates to the field of photographic equipment, in particular relating to a photographic equipment supporting rod.

### BACKGROUND

Photographic equipment supporting rods are often used on tripods, selfie sticks, and other photographic equipment. For easy grip and use, many existing photographic equipment supporting rods usually comprise an inner core and a jacket sheathed outside the inner core. The inner core usually adopts a stainless steel rod, flexible stainless steel wire, a flexible aluminum rod, etc. The jacket is usually supported by foam material. In the production, the jacket and the inner core need to be separately processed and formed. The inner core is then inserted into the jacket, the inner core and the jacket are fixed together with some connecting structures. The structure is relatively complex, and both the processing and assembling are time-consuming and inconvenient. The demand of dimensional accuracy of such jacket and inner core are relatively high, while the production efficiency is low, with higher cost. However, because of the separation of the jacket and inner core, in use, relative slipping between the jacket and the inner core is easy to occur, which tends to wear the jacket and shorten the service life of the jacket, especially in the use of a flexible photographic equipment supporting rod.

### SUMMARY

The present disclosure provides a photographic equipment supporting rod which is easy to be processed and manufactured, improving the production efficiency and reducing the production cost effectively.

Technical solutions adopted by the present disclosure to solve the technical problems thereof are as follows:

A photographic equipment supporting rod comprises an inner core and a jacket, wherein the jacket integrally wraps outside of the inner core or integrally wraps a part of the inner core.

Advantageously, the jacket is adhered on the inner core.

Advantageously, the jacket is formed on the inner core by using foam moulding or injection moulding, so as to wrap outside the inner core or a part of the inner core integrally.

Advantageously, the inner core adopts a flexible metal rod, and the jacket adopts a flexible rubber sheath or a flexible plastic sheath.

Advantageously, the back part of the inner core extends outside the jacket, and the inner core is provided with a fractured notch, located in the jacket and close to the back end of the jacket.

Advantageously, the inner core is in a rod shape, and either the inner core or the jacket is provided with at least one concave part. And the other one is provided with a convex part matching with the concave part, wherein the convex part fills in the concave part to limit the relative rotation and/or movement between the inner core and the jacket.

Advantageously, the inner core is in a rod shape, provided with at least a twisted or bent part located in the jacket.

Advantageously, the inner core is provided with a connecting segment, at the front part of the inner core, extending outside the jacket, and a foot sheath is fixed in the connecting segment.

Advantageously, a mounting hole and a pin hole communicated with the mounting hole are arranged in the foot sheath, wherein the connection segment is inserted in the mounting hole and a pin is inserted in the pin hole. The pin is tightly pressed on the side wall of the connecting segment, bending or deforming the connecting segment, and fixing the foot sheath on the inner core.

Advantageously, the foot sheath is provided with a connecting groove, at the back part of the foot sheath; and the front part of the jacket is embedded in the connecting groove.

The present disclosure has the beneficial effects that: the jacket in the present disclosure wraps outside the inner core or a part of the inner core integrally, so that the jacket can be directly formed on the inner core by using injection moulding or foam moulding during production without needing to be separately processed and assembled with the inner core, requiring less dimension accuracy on the jacket and the inner core. And it is not necessary to additionally provide a connecting structure to fix the jacket and the inner core together. Therefore, the manufacturing process can be effectively simplified, with higher production efficiency and lower cost. Moreover, since the inner core and the sheath are integrated, relative sliding is less likely to occur during usage, preventing wearing and prolonging the service life.

### BRIEF DESCRIPTION OF THE DRAWINGS

The present disclosure will be further described hereinafter in detail with reference to the drawings and specific embodiments.

FIG. 1 is an assembly diagram of a first embodiment according to the present disclosure;

FIG. 2 is a cross-section view of the first embodiment according to the present disclosure;

FIG. 3 is a partial enlarged view of part A in FIG. 2;

FIG. 4 is a cross-section view of the first embodiment according to the present disclosure after disassembly;

FIG. 5 is a partial enlarged view of part B in FIG. 4;

FIG. 6 is a cross-section view of an inner core and a jacket in a second embodiment according to the present disclosure;

FIG. 7 is a partial enlarged view of part C in FIG. 6;

FIG. 8 is a schematic diagram of an optional inner core structure according to the present disclosure; and

FIG. 9 is a schematic diagram of another optional inner core structure according to the present disclosure.

### DETAILED DESCRIPTION

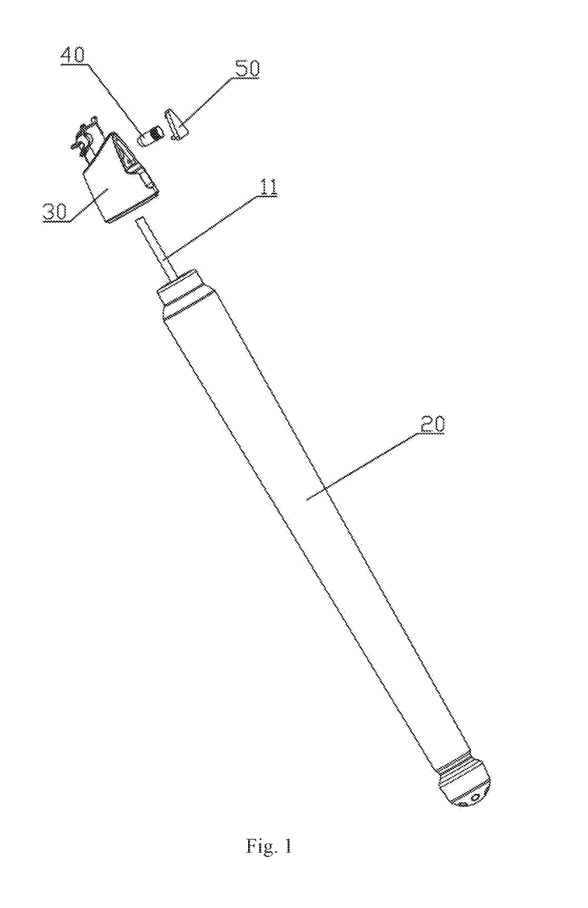

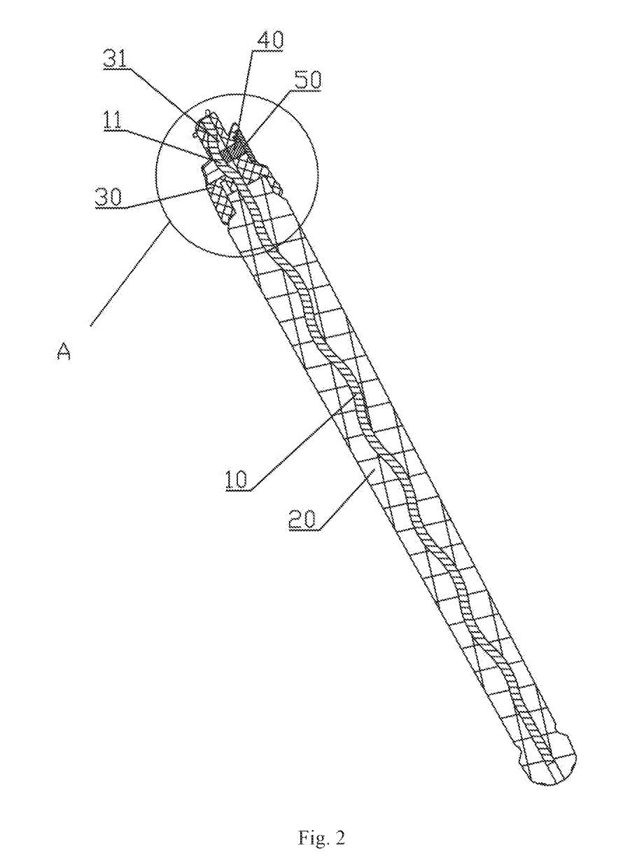

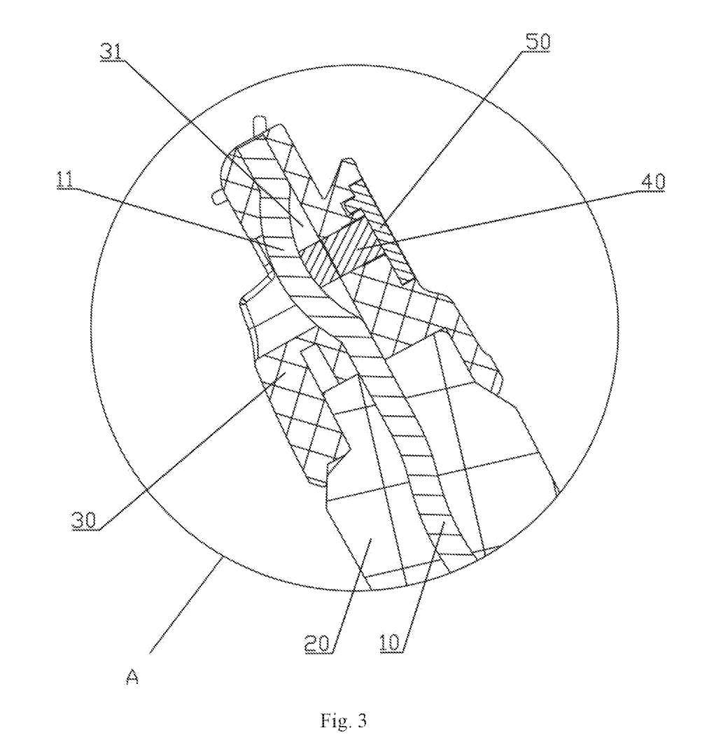

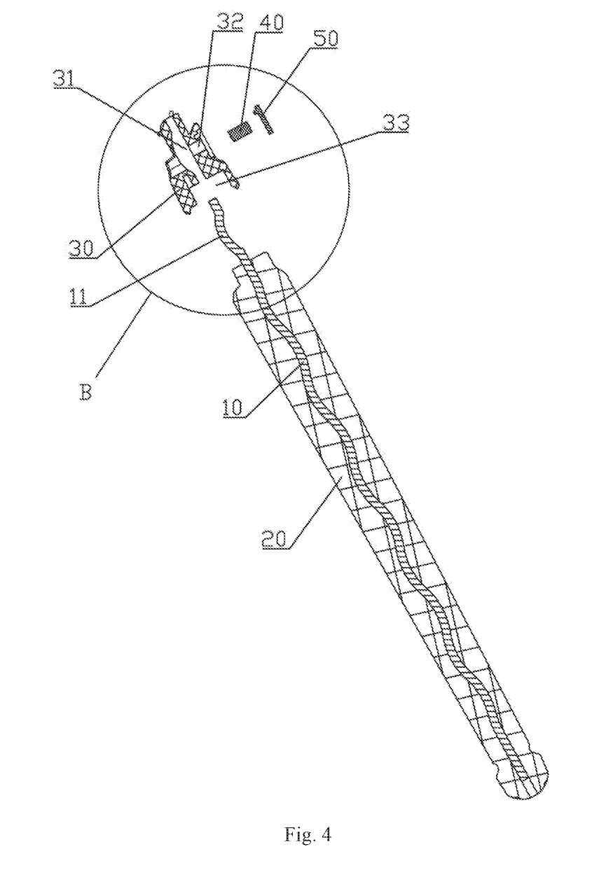

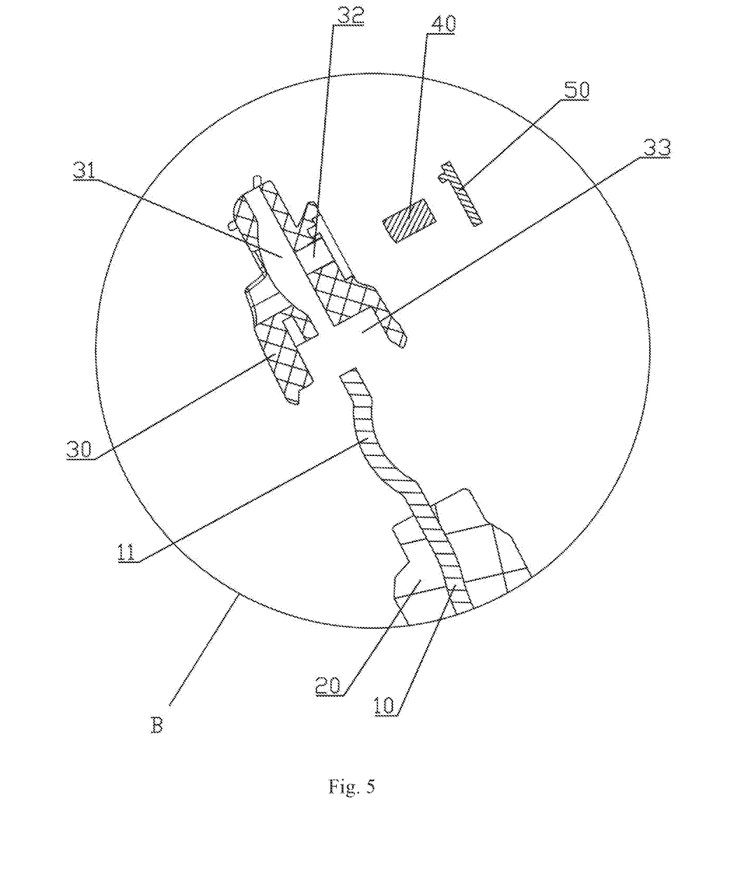

Referring to FIG. 1 to FIG. 5, a photographic equipment supporting rod of the first embodiment according to the present disclosure comprises an inner core 10 and a jacket 20, wherein the jacket 20 integrally wraps the inner core 10 or a part of the inner core 10. In the embodiment, the jacket 20 wraps the middle part of the inner core integrally, of course in application, the jacket 20 may also wrap the inner core 10 completely or only wrap other parts of the inner core 10. Since the jacket 20 in the present disclosure integrally wraps the outside of the inner core 10 or a part of the inner core 10, the jacket 20 can be directly formed on the inner core 10 by using injection moulding or foam moulding during production without needing to be respectively processed and assembled with the inner core 10, requiring less dimension accuracy on the jacket 20 and the inner core 10. And it is not necessary to additionally provide a connecting structure to fix the jacket 20 and the inner core 10 together. Therefore, the manufacturing process can be effectively simplified, with higher production efficiency and lower cost. Moreover, since the inner core 10 and the jacket 20 are integrated, relative sliding is less likely to occur during using, preventing the jacket 20 from being worn, prolonging the service life thereof.

The foam moulding can form the jacket 20 directly outside the inner core 10 by using chemical reaction, while the injection moulding can physically form the jacket 20 outside the inner core 10 by using the thermal melting and cooling of an injection material. Both of the two forming methods are widely used in various fields and have been well known to those skilled in the art, without being described in detail herein. During actual application, the two forming methods can be flexibly selected according to needs. Of course, other feasible processing methods can also be used to integrally wrap the jacket 20 on the inner core 10, but not limited to this. The jacket 20 can be tightly wrapped on the inner core 10 by foam moulding or injection moulding, which can further prevent relative sliding or rotation between the inner core 10 and the jacket 20, prolonging the service life of the photographic equipment supporting rod. Moreover, by properly selecting a foam moulding material or injection moulding material, the jacket 20 can be adhered on the inner core 10 with stickiness, so as to further improve the firmness of connection between the inner core 10 and the jacket 20, and reduce friction. Of course, in practical application, the jacket 20 may also be adhered on the inner core 10 by applying glue or the like between the inner core 10 and the jacket 20. In this embodiment, the inner core 10 is a flexible metal rod with good toughness, and the jacket 20 is a flexible rubber or plastic sheath. Therefore, the photographic equipment supporting rod can be shaped at any bending angle, without being broken, so that the service life of the photographic equipment supporting rod can be prolonged. Moreover, the photographic equipment supporting rod can also be wrapped on other objects to facilitate the fixation and use of the photographic equipment supporting rod. Usually, such flexible metal rod can be manufactured from screwing steel wires. And the flexible rubber and plastic sheath are easy to be processed by foam moulding or injection moulding with flexible materials like foamed PU, foamed EVA, and foamed silica gel, for easy handheld usage. Of course, in practical application, the inner core 10 may also be made of hard metal rods, carbon fiber rods, plastics, or other materials. The jacket 20 may also be made of other suitable materials such as foam, and is not limited thereto.

The inner core 10 is provided with a connecting segment 11, at the front part of the inner core 10, extending outside the jacket 20. The foot sheath 30 is fixed on the connection section, generally used for being connected with a holder of a tripod and a mobile phone fixing clamp of a selfie stick. Since the material of the inner core 10 is generally harder than that of the jacket 20, the foot sheath 30 is mounted on the inner core 10, so that the foot sheath 30 can be firmer and less likely to come loose. A conventional photographic equipment supporting rod usually requires screw holes in the inner core 10, which can be used to fix the foot sheath on the photographic equipment supporting rod. Since the inner core 10 is small, machining and assembling of such structure will be quite inconvenient, with lower structural strength. In this way, the inner core 10 will be easily broken or damaged, resulting in damage to the photographic equipment supporting rod. In the present disclosure, the foot sheath 30 is provided with a mounting hole 31 and a pin hole 32 communicated with the mounting hole 31. The connecting segment 11 is inserted in the mounting hole 31, and a pin 40 is inserted in the pin hole 32, tightly pressed on the side wall of the connecting segment 11, bending or deforming the connecting segment 11 and thus fixing the foot sheath 30 on the inner core 10. The foot sheath 30 can be conveniently and firmly fixed on the inner core 10 through the structure. Moreover, the structural strength of the inner core 10 will not be weakened, with higher production efficiency and lower cost, prolonging the service life. The foot sheath 30 is provided with a connecting groove 33, at the back part of the foot sheath 30, and the front part of the jacket 20 is embedded in the connecting groove 33, which can further increase the structural strength of the photographic equipment supporting rod and prolong the service life. A cover plate 50 is also mounted on the foot sheath 30 which can cover the pin 40 and the pin hole 32 to maintain the aesthetic appearance of the photographic equipment supporting rod, and the cover plate 50 also contacts the back end of the pin 40 to further prevent the pin 40 from loosening. In the embodiment, the sizes of the front and back of the mounting hole 31 are matched with the connecting segment 11, and the middle part of the mounting hole 31 is slightly larger than the connecting segment 11 to accommodate the bent or deformed part of the connecting segment 11. The front and back of the mounting hole 31 can prevent the bent or deformed part of the connecting segment 11 from passing through, so that the foot sheath 30 can be firmly fixed on the inner core 10. Of course, in practical applications, other suitable shapes can also be adopted for the mounting hole 31, and the shape is not limited thereto.

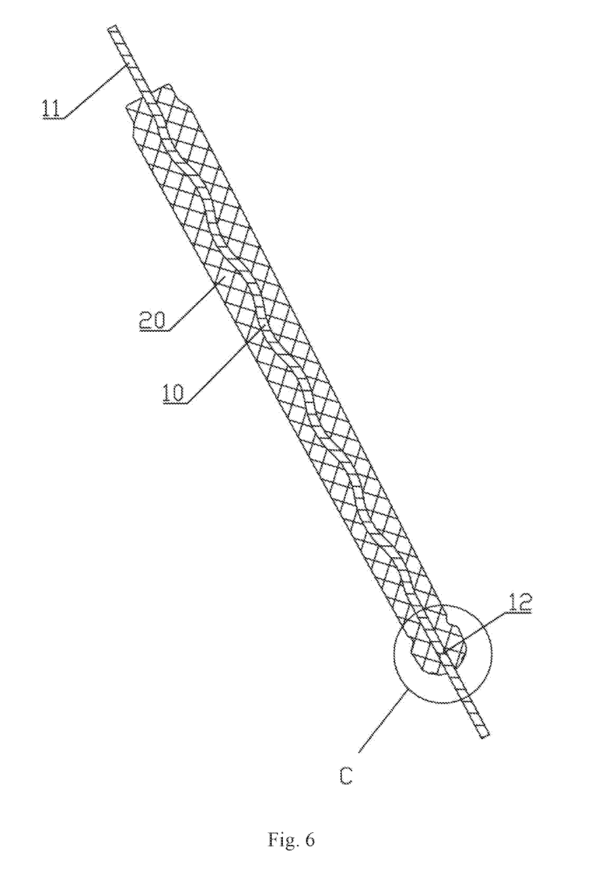

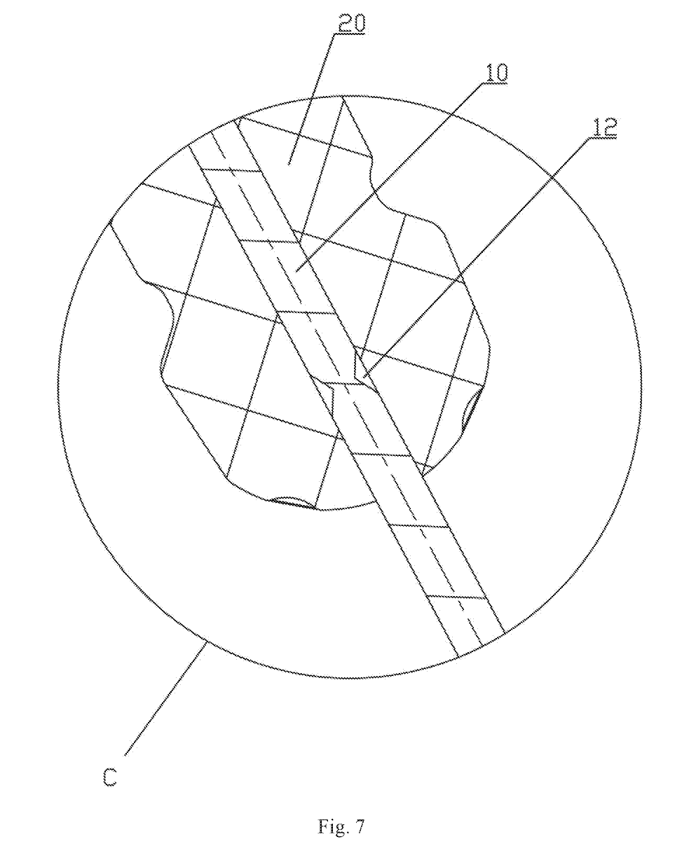

Referring to FIG. 6 and FIG. 7, the second embodiment according to the present disclosure is different from the first embodiment. The inner core 10 extends outside the jacket 20 and the inner core 10 is provided with a fractured notch 12, at the back part of the inner core 10, located in the jacket 20 and close to the back end of the jacket 20. When conducting foam moulding or injection moulding on the jacket 20, the inner core 10 needs to be fixed and located. Usually, both ends of the inner core 10 are clamped by a clamp or the like, and then the middle part of the inner core 10 is foamed or injected. After foaming or injection moulding, a segment of the inner core 10 will remain in the front and back end of the jacket 20, wherein the inner core 10 segment in the front end of the jacket 20 is used to fix the foot sheath 30, and the inner core 10 segment in the back end of the jacket 20 needs to be cut. In this way, if the sharp cut surface remain at the back end of the inner core 10 extending outside the jacket 20, it is easy to scratch the user and also affects the appearance. During practical application, the problem can be solved by additionally installing a foot pad at the back end of the jacket 20. However, this will also increase the structural complexity of the photographic equipment supporting rod, reducing the production efficiency and increasing the production cost. In this embodiment, the fractured notch 12 may be cut out on the inner core 10 before foaming or injection moulding. In this way, after the jacket 20 is formed on the inner core 10, the back part of the inner core 10 needs to be bent back and forth in order to be fractured at the fractured notch 12. Then the excess portion of the back part of the inner core 10 can be taken out, while the fractured surface will be located inside the jacket 20, simplifying the structure of the photographic equipment supporting rod, preventing the user from being scratched, also greatly facilitating the production and manufacture of the photographic equipment supporting rod, and effectively improving the production efficiency.

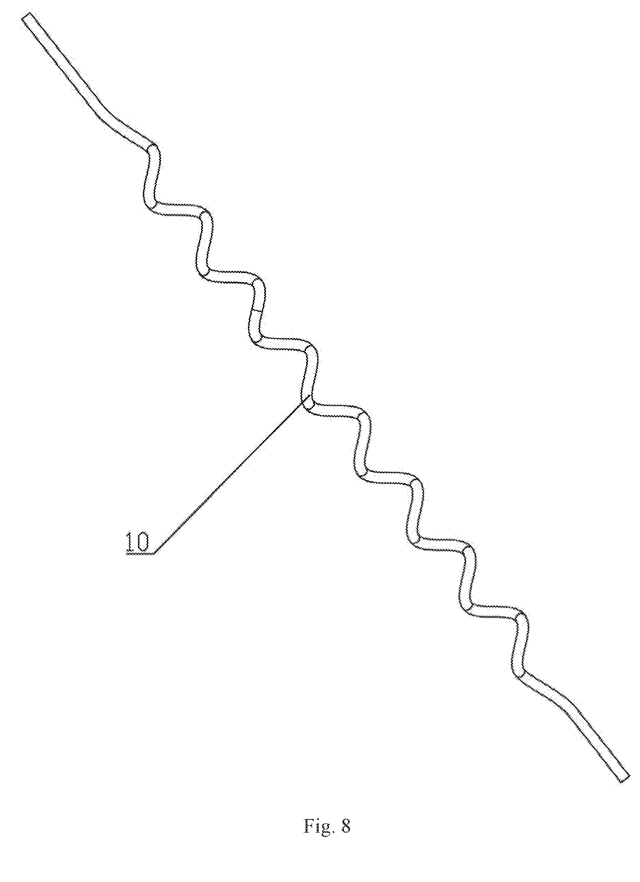

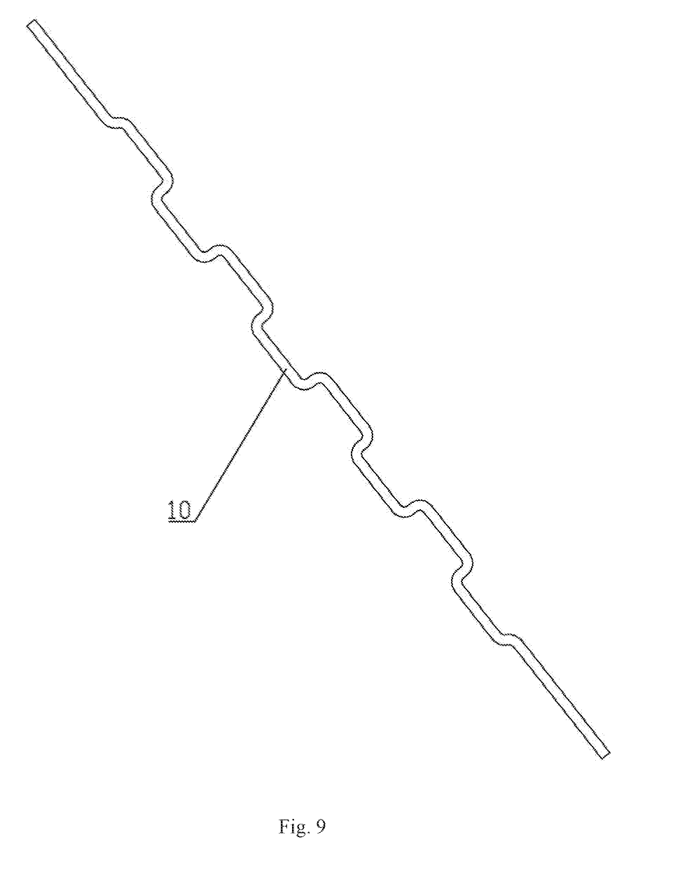

In order to further limit the relative rotation and/or relative movement between the inner core 10 and the jacket 20, preventing the jacket 20 and the inner core 10 from being worn and misaligned, either the inner core 10 or the jacket 20 can be provided with at least one concave part, and the other one can be provided with a convex part, matched with and embedded in the concave part. In the production process of the photographic equipment supporting rod, the concave part or convex part may be provided on the inner core 10 firstly, and then the jacket 20 can automatically form a corresponding convex part or concave part during the moulding process. In practical application, a protrusion block or a groove can be provided on the outer wall of the inner core 10 as the corresponding convex part or concave part. Alternatively, the outer wall of the inner core 10 can be abraded and a convex point on the abrasive surface can be used as the convex part. Alternatively, the inner core 10 may be formed in the shape of a square bar, a triangular prism, or the like, in which case the edge of the inner core may be used as the convex part. Moreover, the cross section of a certain part of the inner core 10 may also be formed in the shape of an ellipse, a cam, or the like, and the other part of the inner core 10 in round shape can be used as the convex part. In practical application, the structures of the convex part and the concave part can be flexibly adjusted according to needs, and are not limited thereto. In addition, at least one twisted part or bent part in the jacket 20 may also be provided in the inner core 10. For example, in the first embodiment and the second embodiment according to the present disclosure, the middle part of the inner core 10 is formed in a wave shape. Another two optional structures of the inner core 10 in the present disclosure are shown in FIGS. 8 and 9. The middle part of the inner core 10 in FIG. 8 is spiral, and the middle part of the inner core 10 in FIG. 9 is bent in a right-angled wave shape. All these structures can prevent the relative movement and rotation between the inner core 10 and the jacket 20. Of course, in practical application, the shape of the inner core 10 can be flexibly adjusted according to the needs, and is not limited thereto.

The above description is only directed to advantageous embodiments according to the present disclosure, and any technical solution that achieves the object according to the present disclosure by using substantially the same ways belongs to the protection scope of the invention.

1. A photographic equipment supporting rod, comprising an inner core and a jacket, wherein the jacket integrally wraps outside of the inner core or a part of the inner core.

2. The photographic equipment supporting rod according to claim 1, wherein the jacket is adhered on the inner core.

3. The photographic equipment supporting rod according to claim 1, wherein the jacket is formed on the inner core by using foam moulding or injection moulding, so as to integrally wrap outside of the inner core or a part of the inner core.

4. The photographic equipment supporting rod according to claim 1, wherein the inner core is a flexible metal rod, and the jacket is a flexible rubber sheath or plastic sheath.

5. The photographic equipment supporting rod according to claim 1, wherein a back part of the inner core extends outside the jacket, and the inner core is provided with a fractured notch, located in the jacket and close to a back end of the jacket.

6. The photographic equipment supporting rod according to claim 1, wherein the inner core is in a rod shape, and either the inner core or the jacket is provided with at least a concave part, and the other one is provided with a convex part matched with the concave part, embedded in the concave part to limit the relative rotation and/or relative movement between the inner core and the jacket.

7. The photographic equipment supporting rod according to claim 1, wherein the inner core is in a rod shape, provided with at least a twisted part or a bent part located in the jacket.

8. The photographic equipment supporting rod according to claim 1, wherein the inner core is provided with a connecting segment, at a front part of the inner core, extending outside the jacket; wherein a foot sheath is fixed on the connecting segment.

9. The photographic equipment supporting rod according to claim 8, wherein the foot sheath is provided with:
a mounting hole where the connecting segment is inserted in; and
a pin hole where a pin is inserted in, communicated with the mounting hole;
the pin tightly pressed on the side wall of the connecting segment to bend or deform the connecting segment, thus fixing the foot sheath on the inner core.

10. The photographic equipment supporting rod according to claim 8, wherein the foot sheath is provided with a connecting groove, at a back part of the foot sheath; wherein a front part of the jacket is embedded in the connecting groove.
